(19) United States
(12) Patent Application Publication
(10) Pub. No.: US 2021/0063930 A1
(43) Pub. Date: Mar. 4, 2021

(54) FIXING DEVICE AND IMAGE FORMING APPARATUS

(71) Applicant: FUJI XEROX CO., LTD., Tokyo (JP)

(72) Inventor: Atsushi FUNADA, Kanagawa (JP)

(73) Assignee: FUJI XEROX CO., LTD., Tokyo (JP)

(21) Appl. No.: 16/835,890

(22) Filed: Mar. 31, 2020

(30) Foreign Application Priority Data
Sep. 3, 2019 (JP) 2019-160051

(51) Int. Cl. G03G 15/20; B65H 29/12

(52) U.S. Cl. CPC G03G 15/2064; G03G 15/2032; B65H 2404/11221; G03G 2215/2025; B65H 29/125

(57) ABSTRACT

A fixing device includes: a pair of pressure members that nip and apply pressure to a recording material having an unfixed image thereon; multiple pressure mechanisms that transmit a force to at least one of the pair of pressure members to generate the pressure; and multiple elastic members that apply elastic forces to a common portion in each pressure mechanism to generate the pressure.

### CROSS-REFERENCE TO RELATED APPLICATIONS

This application is based on and claims priority under 35 USC 119 from Japanese Patent Application No. 2019-160051 filed Sep. 3, 2019.

### BACKGROUND

### (i) Technical Field

The present disclosure relates to a fixing device and an image forming apparatus.

### (ii) Related Art

A fixing device in which a recording material having an unfixed image thereon is nipped at a nip area, and the image is fixed to the recording material by applying or not applying heat, and an image forming apparatus having such a fixing device are known. A fixing device of this type is configured to obtain pressure to be applied at the nip area with an elastic member, such as a spring.

For example, Japanese Unexamined Patent Application Publication No. 2018-155803 discloses a fixing device having a helical compression spring, serving as an urging member that forms a fixing nip part, at which a fixing member and a pressure rotary member are pressed against each other with a predetermined pressure to nip a recording medium.

Japanese Unexamined Patent Application Publication No. 2019-020520 discloses a pressure mechanism including a first pressure lever that retains a pressure member, and a second pressure lever that operates in synchronization with a pressure cam and applies a contact pressure force to the first pressure lever via a first urging member, wherein a fixing member and the pressure member form a fixing nip.

Japanese Unexamined Patent Application Publication No. 2012-013914 discloses a fixing-nip load-changing unit including: a support member, serving as a support member for supporting a rotary shaft of a pressure roller; a spring, serving as an urging member, whose upper end is in pressure contact with the support member; a pressure plate that supports the lower end of the spring; an elliptical pressing cam that comes into contact with the bottom surface of the pressure plate; and a load-changing motor that rotationally drives the pressing cam.

### SUMMARY

In general, fixing devices and image forming apparatuses do not have a large space for an elastic member, and hence, a short elastic member having a large elastic constant is used. However, a short elastic member having a particularly large elastic constant tends to deteriorate with time and to suffer from so-called setting (permanent deformation).

Aspects of non-limiting embodiments of the present disclosure relate to providing a fixing device and an image forming apparatus in which setting of an elastic member is suppressed, compared with a case where fixing pressure is obtained with a single elastic member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: a pair of pressure members that nip and apply pressure to a recording material having an unfixed image thereon; a plurality of pressure mechanisms that transmit a force to at least one of the pair of pressure members to generate the pressure; and a plurality of elastic members that apply elastic forces to a common portion in each pressure mechanism to generate the pressure.

### BRIEF DESCRIPTION OF THE DRAWINGS

Exemplary embodiments of the present disclosure will be described in detail based on the following figures, wherein:

FIG. 1 schematically shows the configuration of a printer corresponding to an exemplary embodiment of an image forming apparatus;

FIG. 2 is a sectional view showing the structure of a fixing device;

FIG. 3 shows a pressure mechanism disposed at the far end, according to a first exemplary embodiment;

FIG. 4 shows a pressure mechanism disposed at the near end, according to the first exemplary embodiment;

FIG. 5 is a perspective view showing the details of coil springs and the like in the pressure mechanism provided in the fixing device according to the first exemplary embodiment;

FIG. 6 is a side view showing the details of the coil springs and the like in the pressure mechanism provided in the fixing device according to the first exemplary embodiment;

FIG. 7 is a perspective view showing the details of the coil springs and the like in the pressure mechanism provided in the fixing device according to a second exemplary embodiment;

FIG. 8 is a side sectional view showing the details of the coil springs and the like in the pressure mechanism provided in the fixing device according to the second exemplary embodiment;

FIG. 9 is a perspective view showing the details of the coil springs and the like in the pressure mechanism provided in the fixing device according to a third exemplary embodiment; and

FIG. 10 is a side sectional view showing the details of the coil springs and the like in the pressure mechanism provided in the fixing device according to the third exemplary embodiment.

### DETAILED DESCRIPTION

Exemplary embodiments of the present disclosure will be described below with reference to the drawings.

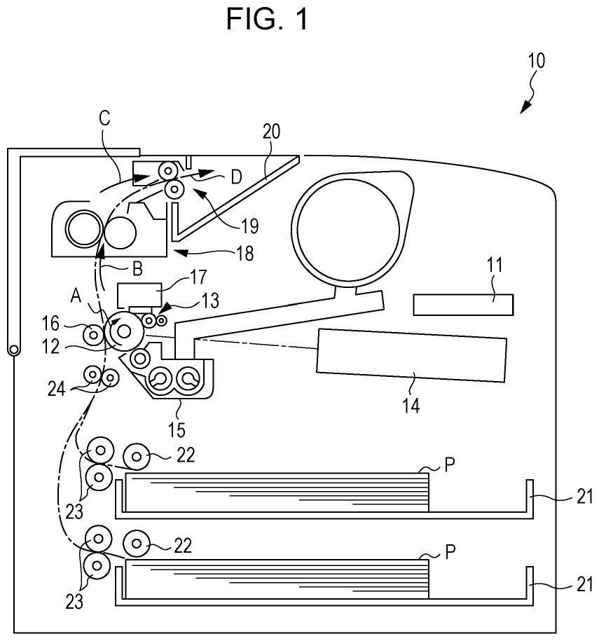

FIG. 1 schematically shows the configuration of a printer corresponding to an exemplary embodiment of an image forming apparatus.

FIG. 1 shows a monochrome printer 10. An image signal generated outside the printer 10 is input to the printer 10 through a signal cable or the like (not shown). The printer 10 includes a controller 11 that controls the operations of the components of the printer 10, and the image signal is input to the controller 11. The printer 10 forms an image according to the image signal, under the control of the controller 11.

The printer 10 has, at the lower part thereof, sheet trays 21 that accommodate a stack of sheets P. The sheet trays 21 can be pulled out from the body of the printer 10 when sheets P are supplied. The sheet trays 21 accommodate sheets P of different sizes.

The sheet trays 21 may accommodate OHP sheets, plastic paper, envelopes, etc., serving as a medium in the present disclosure, instead of paper sheets P. Although the operation of the printer 10 will be described based on an assumption that the sheets P, serving as a medium in the present disclosure, are accommodated in the sheet trays 21 in this exemplary embodiment, the basic operation is the same even when other media are accommodated in the sheet trays 21.

A sheet P in the sheet tray 21 is picked up by a pickup roller 22 and separating rollers 23 and is directed to stand-by rollers 24 thereabove. The sheet P that has reached the stand-by rollers 24 is transported further upward after the transportation timing thereof is adjusted.

The printer 10 includes a cylindrical photoconductor 12 that rotates in the direction of arrow A. A charger 13, an exposure device 14, a developing device 15, a transfer device 16, and a photoconductor cleaner 17 are disposed around the photoconductor 12. The photoconductor 12, the charger 13, the exposure device 14, the developing device 15, and the transfer device 16 collectively serve as an example of an image forming section of the present disclosure.

The charger 13 charges the surface of the photoconductor 12. The exposure device 14 irradiates the surface of the photoconductor 12 with light according to an image signal transmitted from the controller 11 to form an electrostatic latent image thereon. The developing device 15 develops the electrostatic latent image into a toner image.

The stand-by rollers 24 feed the sheet P in accordance with the timing when the toner image on the photoconductor 12 reaches a transfer position where the toner image faces the transfer device 16, so that the sheet P and the toner image simultaneously reach the transfer position. The toner image on the photoconductor 12 is transferred to the sheet P transported thereto by receiving an action from the transfer device 16. This way, an unfixed toner image is formed on the sheet P.

The sheet P with the unfixed toner image is transported in the direction of arrow B (upward) and is fed to the fixing device 18. In the fixing device 18, the sheet P is heated and pressed, and thus, the toner image is fixed to the sheet P. As a result, an image, which is the fixed toner image, is formed on the sheet P. The sheet P heated and pressed in the fixing device 18 is directed to a discharging device 19. The sheet P directed to the discharging device 19 is transported further in the direction of arrow D by the discharging device 19 and is discharged on a sheet output tray 20. The fixing device 18 corresponds to a first exemplary embodiment of the fixing device of the present disclosure.

The structure of the fixing device 18 will be described in more detail below.

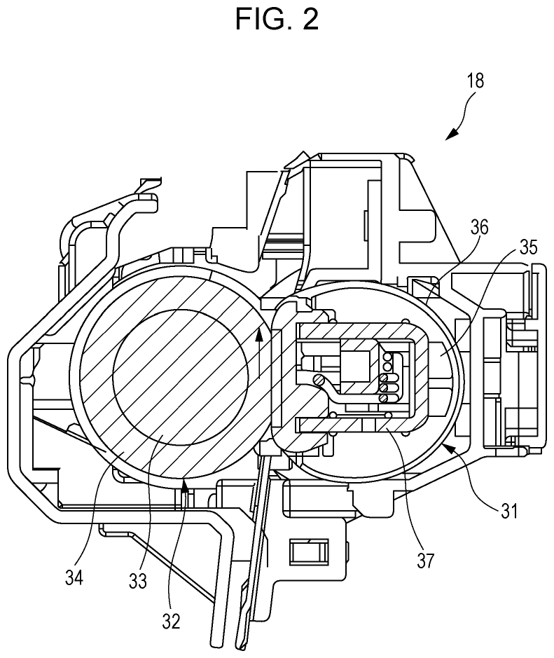

FIG. 2 is a sectional view showing the structure of the fixing device.

The fixing device 18 includes a heating roller 31 having a substantially roller-shaped exterior and extending in the depth direction in FIG. 2, and a pressure roller 32 extending in the depth direction in FIG. 2, parallel to the heating roller 31. The pressure roller 32 applies pressure to a sheet P nipped at a fixing area (or a nip area) between the pressure roller 32 and the heating roller 31 and transports the sheet P upward in FIG. 2 by rotation. The pressure roller 32 is a so-called rubber roller including a metal core 33 and a rubber layer 34 wound therearound. The heating roller 31 is an assembled component formed of multiple parts. The heating roller 31 has a built-in heat source 35 and a heating belt 36 on the outer circumferential surface thereof. The heating belt 36 moves around the heating roller 31 to transfer the heat of the heat source 35 to the fixing area.

When the sheet P having an unfixed image thereon passes between the heating roller 31 and the pressure roller 32, the image is fixed to the sheet P. The heating roller 31 and the pressure roller 32, forming a pair, correspond to an example of a pair of pressure members in the present disclosure.

In the fixing device 18, the pressure to be applied in the fixing area is a parameter that determines the quality of the image to be fixed and the capacity to transport the sheet P. The pressure to be applied in the fixing area is called a “fixing pressure” or a “nip pressure”. In the fixing device 18 according to this exemplary embodiment, for example, the heating roller 31 is urged against the pressure roller 32 to produce fixing pressure. The fixing device 18 has pressure mechanisms 40 that urge the heating roller 31 against the pressure roller 32.

A support member 37 for supporting the entirety of the heating roller 31, which is an assembled component, is built in the heating roller 31. The support member 37 projects from both ends of the heating roller 31 in the depth direction in FIG. 2. The pressure mechanisms 40 apply a force to the projecting ends of the support member 37.

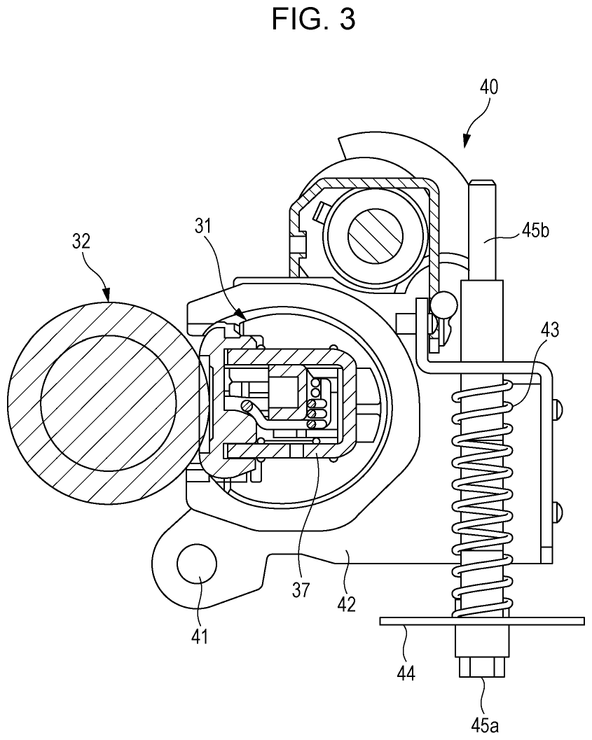

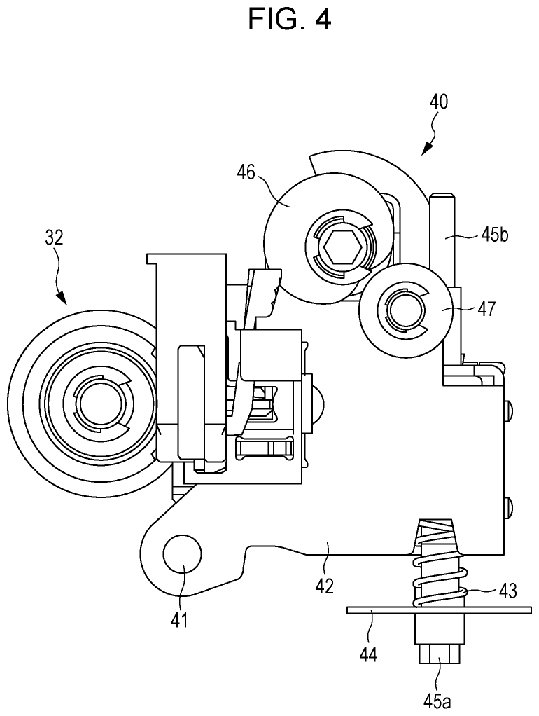

FIGS. 3 and 4 show the pressure mechanisms according to the first exemplary embodiment.

For example, the pressure mechanisms 40, forming a pair, are provided at both ends of the heating roller 31 in the depth direction. FIG. 3 shows the pressure mechanism 40 disposed at the far end of the heating roller 31 in the drawing, and FIG. 4 shows the pressure mechanism 40 disposed at the near end of the heating roller 31 in the drawing. The pressure mechanisms 40 correspond to the pressure mechanisms of the present disclosure.

Each pressure mechanism 40 includes: a lever 42 that can be rotated about a fulcrum 41; a coil spring 43 that presses the lever 42 at one end thereof; a support plate 44 that supports the other end of the coil spring 43; and a support screw 45 having a head 45a and a leg 45b, the head being engaged with the support plate 44 and the leg 45b being screwed into a housing (not shown), thus positioning the support plate 44.

When the coil spring 43 supported by the support screw 45 and the support plate 44 pushes the lever 42 upward in the drawing, the lever 42 rotates about the fulcrum 41 counterclockwise in the drawing and presses the support member 37 of the heating roller 31 toward the pressure roller 32. This pressing force generates the above-described fixing pressure. By adjusting the screwing amount of the support screw 45 and the position of the support plate 44 of each product at a production base, the spring load of the coil spring 43, which generates the fixing pressure, is adjusted to an optimum value.

The spring load is adjusted so as to achieve a so-called full-nip state, in which the maximum fixing pressure required at the fixing area is generated. The full-nip state is not constantly maintained in the fixing device 18, and sometimes the heating roller 31 needs to be brought away from the pressure roller 32 compared with the position thereof in the full-nip state, as necessary to, for example, enable removal of a jammed sheet P or to enable transportation of a thick sheet P. The pressure mechanism 40 has a cam 46 and a cam follower 47, which serve as a mechanism for bringing the heating roller 31 away from the pressure roller 32.

The rotary shaft of the cam 46 is held by the housing of the fixing device 18. In the state in FIG. 4, a cam surface is separated from the cam follower 47, and the full-nip state is achieved. When the cam 46 in the state in FIG. 4 is rotated, the cam surface comes into contact with and presses the cam follower 47. Because the cam follower 47 is fixed to the lever 42, the cam follower 47 pressed by the cam surface moves the lever 42 away from the pressure roller 32. As a result, the heating roller 31 pressed by the lever 42 also moves away from the pressure roller 32, and thus, the fixing pressure decreases. When the cam surface presses the cam follower 47 to a maximum, the heating roller 31 is separated from the pressure roller 32, making removal of a jammed sheet P easy.

As described above, in the pressure mechanism 40, the fixing pressure is generated by the elastic force of the coil spring 43. If the coil spring 43 has to have a large spring constant, the coil spring 43 needs to be formed of a hard material and, thus, is likely to suffer from setting. Furthermore, the coil spring 43 having a large spring constant requires a powerful driving system for the cam 46, which changes the fixing pressure, leading to an increase in cost.

In the pressure mechanism 40 provided in the fixing device 18 according to this exemplary embodiment, an effort to reduce the spring constant of the coil spring 43 has been made.

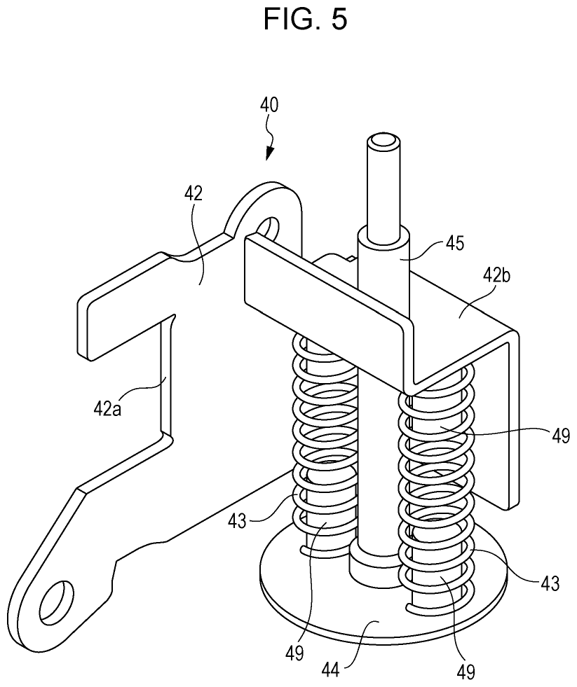

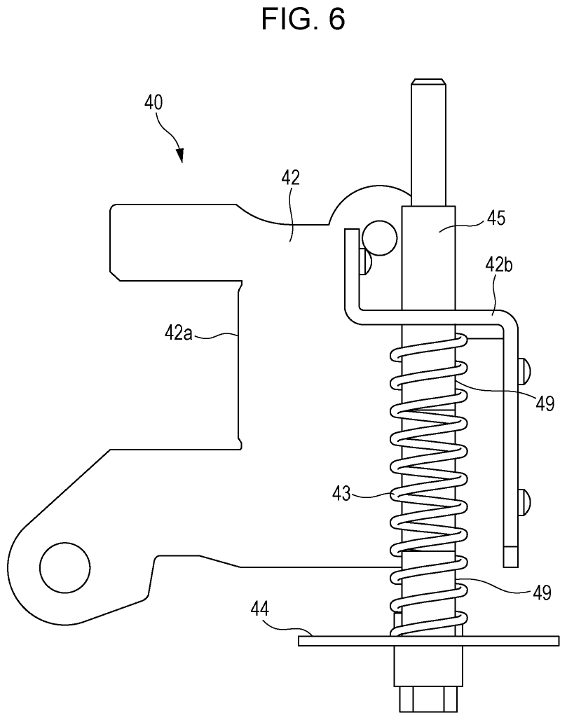

FIGS. 5 and 6 show the details of the coil springs and the like in the fixing device provided in the pressure mechanism according to the first exemplary embodiment. FIG. 5 is a perspective view, and FIG. 6 is a side view.

As described above, the pressure mechanism 40 includes the lever 42, the coil spring 43, the support plate 44, and the support screw 45.

The lever 42 pushes the support member 37 of the heating roller 31 (see FIG. 3) at a cut-away portion 42a and receives the force of the coil spring 43 at a partition portion 42b. The pressure mechanism 40 has multiple (for example, two) coil springs 43 having the same diameter, disposed parallel to each other. The coil springs 43 push the partition portion 42b of the lever 42 with first ends thereof. Furthermore, second ends of the coil springs 43 are supported by the support plate 44. Because the coil springs 43 share the force, the spring constant of each coil spring 43 is small. The coil springs 43 are an example of multiple elastic members of the present disclosure.

Now, the specifications of the springs in Comparison Example, in which only one coil spring is provided, and that in this exemplary embodiment, in which two coil springs 43 are provided, are compared.

When a required spring load is, for example, 86 N, for example, a spring having an outside diameter of 13.2 mm, a wire diameter of 2.3 mm, and a spring constant of 19.4 N/mm is required in Comparison Example. The spring is made of a hard material and thus is likely to suffer from setting. In contrast, in this exemplary embodiment, because the spring load, 86 N, is shared by the two coil springs 43, the spring load for each coil spring 43 is 43 N. Each coil spring 43 has, for example, an outside diameter of 11 mm, a wire diameter of 1.5 mm, and a spring constant of 4.7 N/mm. Hence, the spring constant in this exemplary embodiment is far smaller than that in Comparison Example.

As described above, the position of the support plate 44 is adjusted by the support screw 45, and the spring load of the coil springs 43 is adjusted by adjusting the position of the support plate 44. In other words, because the spring loads of the multiple coil springs 43 are adjusted by adjusting the position of the single support plate 44 with the single support screw 45, the adjustment is easy.

The support plate 44 and the partition portion 42b of the lever 42 have orientation-maintaining rods 49 projecting toward the inside of the coil springs 43 and enter the coil springs 43 from the ends thereof. The orientation-maintaining rods 49 are in contact with the inner circumferences of the coil springs 43 and maintain the orientation of the coil springs 43. In other words, the orientation-maintaining rods 49 suppress movement of the coil springs 43 in a direction intersecting the central axes of the coil springs 43. Because the orientation-maintaining rods 49 maintain the orientation of the coil springs 43, the force of the coil springs 43 is transmitted in a correct direction to the partition portion 42b.

Next, a fixing device according to a second exemplary embodiment will be described. Because the fixing device according to the second exemplary embodiment differs from that according to the first exemplary embodiment only in the structure around the coil springs, only the difference will be described, and overlapping descriptions will be omitted.

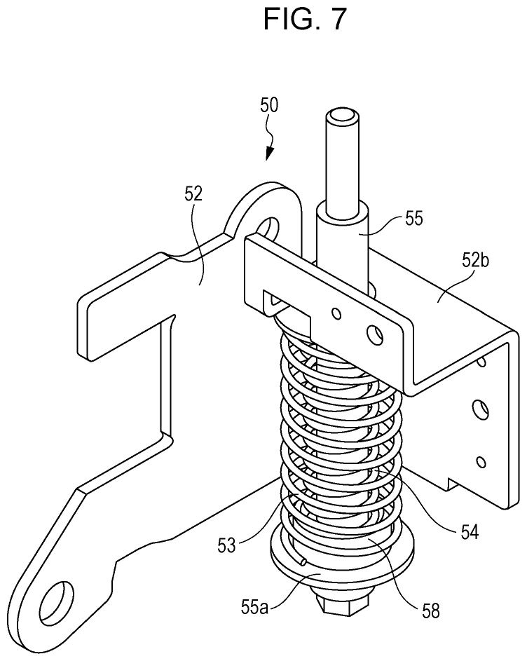

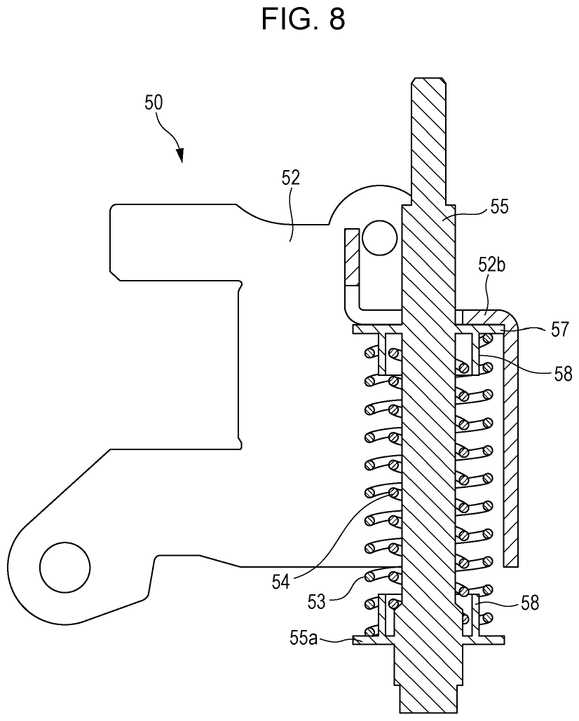

FIGS. 7 and 8 show the details of the coil springs and the like in the pressure mechanism provided in the fixing device according to the second exemplary embodiment. FIG. 7 is a perspective view, and FIG. 8 is a side sectional view.

A pressure mechanism 50 according to the second exemplary embodiment includes a lever 52, which is similar to one provided in the pressure mechanism 40 according to the first exemplary embodiment. The pressure mechanism 50 according to the second exemplary embodiment also includes a support-and-adjustment member 55 corresponding to the combination of the support plate 44 and the support screw 45 of the pressure mechanism 40 according to the first exemplary embodiment.

Whereas the pressure mechanism 40 according to the first exemplary embodiment has two coil springs 43 having the same diameter and disposed parallel to each other, the pressure mechanism 50 according to the second exemplary embodiment has a large-diameter coil spring 53 and a small-diameter coil spring 54, which are disposed coaxially. In the second exemplary embodiment, the space is saved by coaxially disposing the coil springs.

First ends of the large-diameter coil spring 53 and the small-diameter coil spring 54 press a partition portion 52b of the lever 52 in parallel. An intermediate member 57, through which a support-and-adjustment member 55 passes, is provided on the partition portion 52b, on the side where the coil springs 53 and 54 are provided. The coil springs 53 and 54 press the partition portion 52b via the intermediate member 57. Furthermore, second ends of the large-diameter coil spring 53 and the small-diameter coil spring 54 are supported by a plate-like portion 55a of the support-and-adjustment member 55. By adjusting the screwing amount of the support-and-adjustment member 55, the spring loads of the large-diameter coil spring 53 and the spring load of the small-diameter coil spring 54 are simultaneously adjusted. The elastic members that are disposed coaxially are not limited to coil springs, but may be other hollow members that can be disposed coaxially.

Now, the specifications of the springs in Comparison Example, in which only one coil spring is provided, and that in this exemplary embodiment, in which the large-diameter coil spring 53 and the small-diameter coil spring 54 are provided, are compared.

As described above, the specifications of the springs in Comparison Example are such that, for example, the outside diameter is 13.2 mm, the wire diameter is 2.3 mm, and the spring constant is 19.4 N/mm. In contrast, in this exemplary embodiment, because the spring load, 86 N, is shared by the two coil springs 53 and 54, the spring load for each of the coil springs 53 and 54 is, for example, 43N. The large-diameter coil spring 53 has, for example, an outside diameter of 14.5 mm, a wire diameter of 1.7 mm, and a spring constant of 4.3 N/mm. The small-diameter coil spring 54 has, for example, an outside diameter of 9.8 mm, a wire diameter of 1.5 mm, and a spring constant of 6.2 N/mm.

The plate-like portion 55a of the support-and-adjustment member 55 and the intermediate member 57 have cylindrical orientation-maintaining walls 58 projecting between the large-diameter coil spring 53 and the small-diameter coil spring 54. The orientation-maintaining walls 58 are in contact with the inner circumference of the large-diameter coil spring 53 and maintain the orientation of the large-diameter coil spring 53. In other words, the orientation-maintaining walls 58 suppress movement of the large-diameter coil spring 53 in a direction intersecting the central axis of the large-diameter coil spring 53, thus preventing contact between the large-diameter coil spring 53 and the small-diameter coil spring 54. Although the orientation-maintaining walls 58 may be in contact with the outer circumference of the large-diameter coil spring 53 to maintain the orientation of the large-diameter coil spring 53, the orientation-maintaining walls 58 that are in contact with the inner circumference of the large-diameter coil spring 53 more reliably prevent contact between the large-diameter coil spring 53 and the small-diameter coil spring 54.

In the second exemplary embodiment, the orientation of the small-diameter coil spring 54 is maintained by the support-and-adjustment member 55, which penetrates therethrough and whose outer circumferential surface is in contact with the inner circumference of the small-diameter coil spring 54.

Next, a fixing device according to a third exemplary embodiment will be described. Because the fixing device according to the third exemplary embodiment differs from that according to the second exemplary embodiment only in the structure for maintaining the orientation of the coil springs, only the difference will be described, and overlapping descriptions will be omitted.

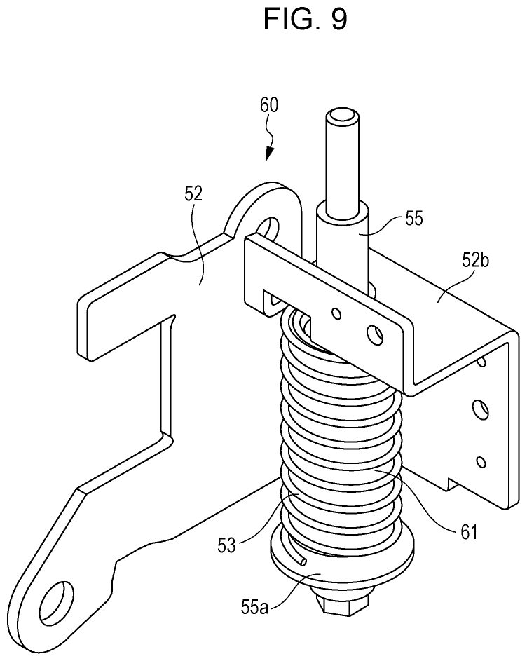

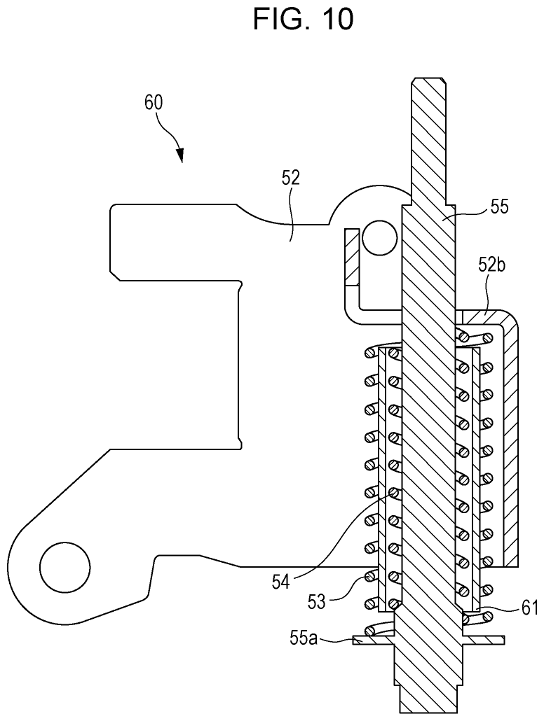

FIGS. 9 and 10 show the details of the coil springs and the like in the pressure mechanism provided in the fixing device according to the third exemplary embodiment. FIG. 9 is a perspective view, and FIG. 10 is a side sectional view.

Also in a pressure mechanism 60 according to the third exemplary embodiment, similarly to the pressure mechanism 50 according to the second exemplary embodiment, the orientation of the small-diameter coil spring 54 is maintained by the support member 55 penetrating therethrough.

Meanwhile, in the third exemplary embodiment, a cylindrical orientation-maintaining tube 61 inserted between the small-diameter coil spring 54 and the large-diameter coil spring 53 maintains the orientation of the large-diameter coil spring 53. The orientation-maintaining tube 61 surrounds the outer circumference of the small-diameter coil spring 54, and the outer circumferential surface of the orientation-maintaining tube 61 is in contact with the inner circumference of the large-diameter coil spring 53. By providing the orientation-maintaining tube 61, contact between the small-diameter coil spring 54 and the large-diameter coil spring 53 is prevented. Furthermore, the pressure mechanism 60 having the orientation-maintaining tube 61 has a simple structure and is easy to assemble.

Although the fixing devices of a type that apply heat and pressure have been described as an example of the fixing device in the present disclosure, the fixing device in the present disclosure may be of a type that applies pressure and no heat.

Furthermore, although the pressure mechanisms that urge the heating roller against the pressure roller have been described as an example of the pressure mechanism in the present disclosure, the pressure mechanism in the present disclosure may urge the pressure roller against the heating roller.

Furthermore, although the coil springs have been described as an example of the multiple elastic members in the present disclosure, the multiple elastic members in the present disclosure may be springs other than coil springs, or may be rubber. Furthermore, although push springs have been described as an example of the multiple elastic members in the present disclosure, the multiple elastic members in the present disclosure may be members that utilize a pulling force.

Furthermore, although the combination of the roller member and the belt member has been described as an example of a pair of pressure members in the present disclosure, the pair of pressure members in the present disclosure may be a pair of roller members or a pair of belt members.

Furthermore, although a monochrome printer has been described as an example of the image forming apparatus in the present disclosure, the image forming apparatus in the present disclosure may be a color printer, a copier, a facsimile machine, or a multi-function apparatus.

Furthermore, although an electrophotographic printer has been described as an exemplary embodiment of the image forming apparatus in the present disclosure, the image forming apparatus in the present disclosure may employ a system other than the electrophotographic system.

Furthermore, although the present disclosure addresses the problem described in the beginning of the summary section above, the configuration disclosed in the present disclosure may be applied to other purposes without addressing the above-described problem, and such applications are also exemplary embodiments of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A fixing device comprising:
a pair of pressure members that nip and apply pressure to a recording material having an unfixed image thereon;
a plurality of pressure mechanisms that transmit a force to at least one of the pair of pressure members to generate the pressure; and
a plurality of elastic members that apply elastic forces to a common portion in each pressure mechanism to generate the pressure.

2. The fixing device according to claim 1, further comprising an adjustment mechanism, wherein
the elastic members apply a force to the common portion, which is common to the plurality of elastic members, at first ends thereof, and
the adjustment mechanism has one adjustment member with which second ends of the elastic members, opposite to the first ends, are in contact, and
the adjustment mechanism adjusts a magnitude of the pressure when the position of the adjustment member is adjusted.

3. The fixing device according to claim 1, wherein the plurality of elastic members include at least one hollow member and are disposed coaxially.

4. The fixing device according to claim 2, wherein the plurality of elastic members include at least one hollow member and are disposed coaxially.

5. The fixing device according to claim 3, further comprising a suppressing member that comes into contact with an inner circumference or an outer circumference of the hollow member to suppress movement of the hollow member in a direction intersecting an axis thereof.

6. The fixing device according to claim 4, further comprising a suppressing member that comes into contact with an inner circumference or an outer circumference of the hollow member to suppress movement of the hollow member in a direction intersecting an axis thereof.

7. The fixing device according to claim 5, wherein
the at least one hollow member comprises a plurality of hollow members, and
the suppressing member is a tubular member that surrounds an outer circumference of one hollow member disposed on the inner side.

8. The fixing device according to claim 6, wherein
the at least one hollow member comprises a plurality of hollow members, and
the suppressing member is a tubular member that surrounds an outer circumference of one hollow member disposed on the inner side.

9. The fixing device according to claim 1, wherein the plurality of elastic members are disposed parallel to each other.

10. The fixing device according to claim 2, wherein the plurality of elastic members are disposed parallel to each other.

11. The fixing device according to claim 9, further comprising suppressing members, wherein
the plurality of elastic members are hollow members, and
the suppressing members come into contact with inner circumferences or outer circumferences of the hollow members to suppress movement of the hollow members in directions intersecting axes thereof.

12. The fixing device according to claim 10, further comprising suppressing members, wherein
the plurality of elastic members are hollow members, and
the suppressing members come into contact with inner circumferences or outer circumferences of the hollow members to suppress movement of the hollow members in directions intersecting axes thereof.

13. The fixing device according to claim 11, wherein the suppressing members have rod-like projections inserted from ends of the hollow members.

14. The fixing device according to claim 12, wherein the suppressing members have rod-like projections inserted from ends of the hollow members.

15. An image forming apparatus comprising:
an image forming section that forms an unfixed image on a recording material for holding an image; and
a fixing device that fixes the unfixed image to the recording material,
wherein the fixing device includes a pair of pressure members that nip and apply pressure to the recording material having the unfixed image thereon, a plurality of pressure mechanisms that transmit a force to at least one of the pair of pressure members to generate the pressure; and a plurality of elastic members that apply elastic forces to common portions of the pressure mechanisms to generate the pressure.

16. A fixing device comprising:
a pair of pressure members that nip and apply pressure to a recording material having an unfixed image thereon;
a plurality of pressure means for transmitting a force to at least one of the pair of pressure members to generate the pressure; and
a plurality of elastic members that apply elastic forces to a common portion in each pressure means to generate the pressure.
